(19) United States
(12) Patent Application Publication
(10) Pub. No.: US 2003/0085915 A1
(43) Pub. Date: May 8, 2003

(54) Website, method and system for customizing designer products

(76) Inventors: Barry R. Mumm, Minnetonka, MN (US); Mary E. Rolf, Minneapolis, MN (US)

Correspondence Address: John Veldhuis-Kroeze, WESTMAN CHAMPLIN & KELLY, Suite 1600 - International Centre, 900 South Second Avenue, Minneapolis, MN, 55402-3319, US

(21) Appl. No.: 10/005,501

(22) Filed: Nov. 2, 2001

(51) Int. Cl. G09G 5/00

(52) U.S. Cl. 345/738; 703/21

(57) ABSTRACT

A method of providing designer product information to a customer of a designer product manufacturer in order to customize designer products includes transmitting computer executable instructions over a computer network to a client computer, which when executed on the client computer cause a web browser on the client computer to prompt the customer to input designer product configuration preferences. The preferences input by the customer are then received over the computer network at a web server. Then, drawing data is retrieved from a database of pre-prepared drawings for a designer product corresponding to the designer product configuration preferences input by the customer. Computer executable instructions corresponding to the retrieved drawing data are then transmitted to the client computer. When executed on the client computer, these computer executable instructions cause the web browser on the client computer to display the drawing of the designer product corresponding to the preferences input by the customer. The customer can then use the web browser to directly order the designer product, or to download any of multiple available file types corresponding to the designer product drawing.

### BACKGROUND OF THE INVENTION

The present invention relates to customization of designer products such as office furniture system workstations. More particularly, the present invention relates to a website, method and system for providing designer product information to a customer of a designer product manufacturer in order to customize designer products comprised of combinations of components and/or modules.

In designer product industries, manufacturers of designer products work with dealers and/or their ultimate purchasers (collectively referred to herein as “customers”) to prepare CAD (computer aided drawing) or other types of drawings corresponding to the customer's designer product configuration preferences. One example of a designer product industry is the space planning industry. In the space planning industry, manufacturers of office furniture system workstations (i.e. modular desks, shelving, cubical walls, etc.) work with customers to prepare CAD or other types of drawings corresponding to the customer's workstation configuration preferences. Typical space planning compatible drafting programs include, but are not limited to, AutoCAD and GIZA.

After an AutoCAD (or GIZA) specialist at the manufacturer spends several hours generating the drawings for the particular configuration preferences expressed by the customer, any changes in the customer's request will typically require several more hours of time in order to regenerate the drawings and related files. The related files in the space planning industry can include, for example, Standard Interface Files (.sif) and Bill of Materials Files (.rtf). The .sif and .rtf files contain information, for the particular manufacturers, such as part numbers, quantities and list prices.

After a space planning drawing specialist employed by the manufacturer completes the drawing and related files for a customer's stated workstation configuration preferences, it is common for the customer to change his or her mind several times, each time changing the workstation configuration preferences which the space planning drawing specialist used to generate the drawings. Further, it is common for customers to forget to specify one or more features, components or modules when ordering a workstation. Since each change from the original set of workstation configuration preferences can result in hours of additional work for the space planning drawing specialist, this process has proven to be frequently time consuming and relatively inefficient.

This type of problem is not limited to the space planning industry, but rather, this type of problem is experienced in various other designer product industries. “Designer products” are defined for this document as products which require a computer drawing specialist to prepare or customize computer drawings of the particular products, or an interior designer to prepare computer or non-computer drawings of the particular products, based upon customer preferences on a case by case basis. For example, in addition to the space planning industry which includes manufacturers of office furniture system workstations, designer product manufacturers include cabinet manufacturers, window manufacturers, custom home furniture manufacturers, and others.

One contemplated solution to this type of problem is to develop a web-based CAD program allowing the customer to prepare CAD drawings for their desired designer product using a web browser to access the CAD program from the manufacturer's host server. While this solution would potentially reduce the work load on the designer product drawing specialist employed by the manufacturer, a web-based CAD program would be extremely expensive to develop and would require a great deal of transmission bandwidth to use. Further, a web-based CAD program would require the user to become proficient with the CAD system, which is an overly burdensome requirement in most cases. Likewise, dial-up (i.e. non-web) access to proprietary software on the manufacturer's system is burdensome for the same reason.

Consequently, a designer product system for helping a customer of a designer product manufacturer to customize designer products, which overcomes the above-described and other problems, would be a significant advancement of the art.

### SUMMARY OF THE INVENTION

A method of providing designer product information to a customer of a designer product manufacturer in order to customize designer products includes transmitting computer executable instructions over a computer network to a client computer, which when executed on the client computer cause a web browser on the client computer to prompt the customer to input designer product configuration preferences. The preferences input by the customer are then received over the computer network at a web server. Then, drawing data is retrieved from a database of pre-prepared drawings for a designer product corresponding to the designer product configuration preferences input by the customer. Computer executable instructions corresponding to the retrieved drawing data are then transmitted to the client computer. When executed on the client computer, these computer executable instructions cause the web browser on the client computer to display the drawing of the designer product corresponding to the preferences input by the customer. The customer can then use the web browser to directly order the designer product, or to download any of multiple available file types corresponding to the designer product drawing.

In one exemplary embodiment, the designer products are office furniture system workstations. In other embodiments, the designer products are other types of customizable products which require an interior designer or a drawing specialist to prepare drawings for each customer based upon the customer's particular preferences.

### BRIEF DESCRIPTION OF THE DRAWINGS

FIG. 1 is a block diagram illustrating a web-based designer product customizing system in accordance with embodiments of the present invention.

FIG. 2 is a block diagram of an exemplary computer environment such as can be used as a client computer operated by a customer and used to access the designer product customizing system illustrated in FIG. 1.

FIGS. 3-10 are pictorial representations of a display or monitor of the client computer shown in FIGS. 1 and 2, illustrating web page features of the designer product customizing system in accordance with an example embodiment of the invention.

FIG. 11 is a block diagram illustrating a method of providing designer product information to a customer of a designer product manufacturer in accordance with the present invention.

### DETAILED DESCRIPTION OF ILLUSTRATIVE EMBODIMENTS

The present invention provides a unique solution to the above-described problems faced by manufacturers of designer products such as office furniture system workstations. The invention includes a method of providing designer product information to a customer of a designer product manufacturer in order to customize designer products. The present invention also includes computer systems, such as web server and client based computer systems, which embody the disclosed method. Further, the present invention includes other embodiments such as computer readable medium containing computer executable instructions which implement the methods of the invention.

The present invention is described in the following description with reference to a particular type of designer product, office furniture workstations used in the space planning industry. However, the following description and claims should be interpreted to include other types of designer products. Consequently, the described space planning website and method is only one of many embodiments of the designer product customizing websites and methods of the present invention.

In accordance with an embodiment of the present invention, a space planning website allows customers (i.e. dealers and ultimate purchasers) to develop simple drawings of workstations. The website, which is protected by the use of private IDs and passwords, prompts the user of the site to click on various options (product line, size, orientation, quantity, configuration, etc.) which they would like. As the user makes these selections, the system retrieves the appropriate plan view drawing (or other drawing type) from a large data base of pre-drawn workstation layouts for the manufacturer's product line. In association with the drawing of the workstation configuration corresponding to the customer preferences, the website displays links to a number of corresponding workstation related files which the user can download if desired. The different files related to the particular workstation can be downloaded to the customer's computer system for further manipulation if desired.

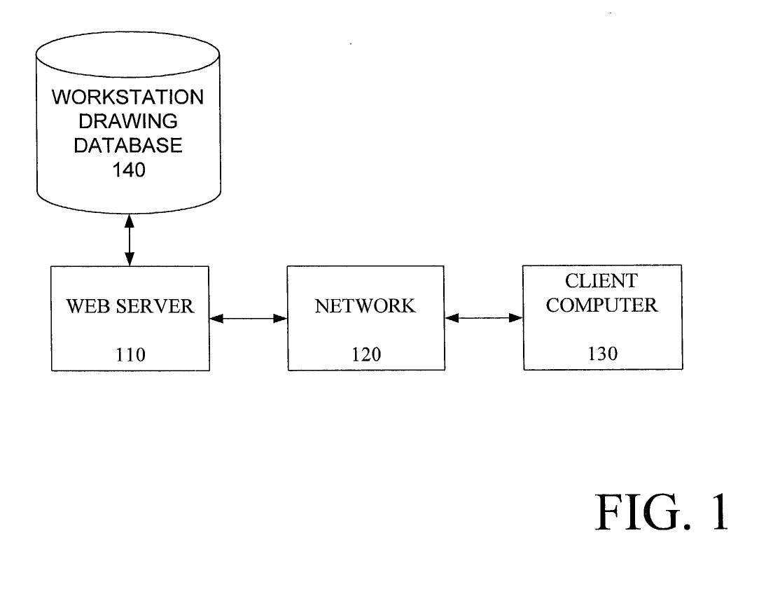

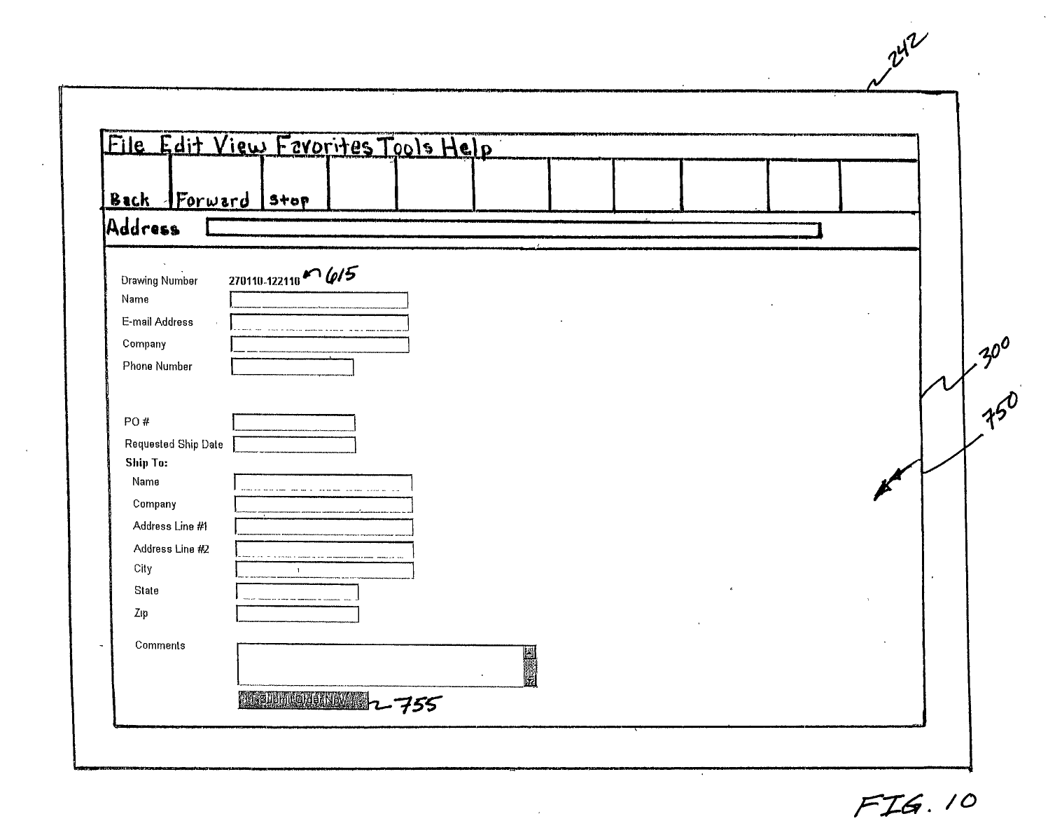

When a customer of the manufacturer has used a web browser to input workstation configuration preferences, computer executable instructions are transmitted to the client computer in order to cause the client computer to display a 3-dimensional view (or other view) of a workstation corresponding to the specified configuration preferences. The computer executable instructions transmitted to the client computer also cause the web browser to prompt or allow the user to add, change and delete components (i.e., fabric grade, storage, shelving, keyboard supports, etc.). When the customer has finished adding, changing or deleting components, the system updates the 3-dimensional view by retrieving another of a large number of pre-prepared drawings from a data base, and the customer is presented with the drawing number and file selections for the new configuration. The customer can select and download any of the large number of file types for their particular system. Also, if the customer wishes to order the exact office system workstation as shown in the pre-prepared typical drawing, they can enter the order using a submit button displayed on the web browser. This causes the order to be e-mailed or otherwise transmitted to the manufacturer. In the alternative, the user can choose to download a particular related file type, and to make changes to it via their own software (i.e. GIZA or Auto CAD). These changes can then be e-mailed, faxed or otherwise sent to the manufacturer to place an order. Further, a .sif file corresponding to a particular configuration can be automatically received and loaded into the manufacturer's business system, thus eliminating the order entry step. A more detailed discussion of these methods and systems of the present invention is provided below with reference to FIGS. 1-11.

FIG. 1 is a block diagram of a computer system in accordance with embodiments of the invention. The computer system can be a web-based computer system which utilizes the internet as a computer network for communication, or it can be a computer system which utilizes other computer networks for communication. In either case, the computer system utilizes a web browser or other similar non-proprietary software operating on a client computer at a customer location to access a manufacturer web page or computer system in order to customize office furniture system workstations. The phrase “non-proprietary software” is intended to reference software products, such as Internet web browsers, which are in common use by the general public. The phrase is not intended to represent that the software can be freely copied without compliance with the terms of any license agreements with the owner of the software.

In one embodiment, the computer system illustrated in FIG. 1 includes a web server 110 which hosts a web page for a manufacturer of office furniture system workstations. The web server 110 utilizes a computer network 120, for example the internet, to transmit computer executable instructions to a client computer 130 operated by a customer. Web server 110 also receives, over network 120, data input into client computer 130 by the customer.

Web server 110 is coupled in communication with a workstation drawing database 140 which can be, for example, stored in memory of the web server, memory on a separate hard drive, or on other memory devices. Workstation drawing database 140 contains a large number of typical workstation layouts for the particular manufacturer, each corresponding to a different set of customer workstation configuration preferences. A workstation, as defined herein, is a combination of components and modules (i.e., sub-assembles) forming an office furniture system. Generally, the term workstation is intended to represent a top-level (or near top-level) office furniture system configuration. The term workstation is distinguished from the component parts and/or modules which collectively define a workstation. In a broader context, a designer product is also defined herein as a combination of components and modules. As described above, a designer product is further defined as a product which requires a computer drawing specialist to prepare or customize computer drawings of the particular product, or an interior designer to prepare computer or non-computer drawings of the particular product, based upon customer preferences on a case by case basis.

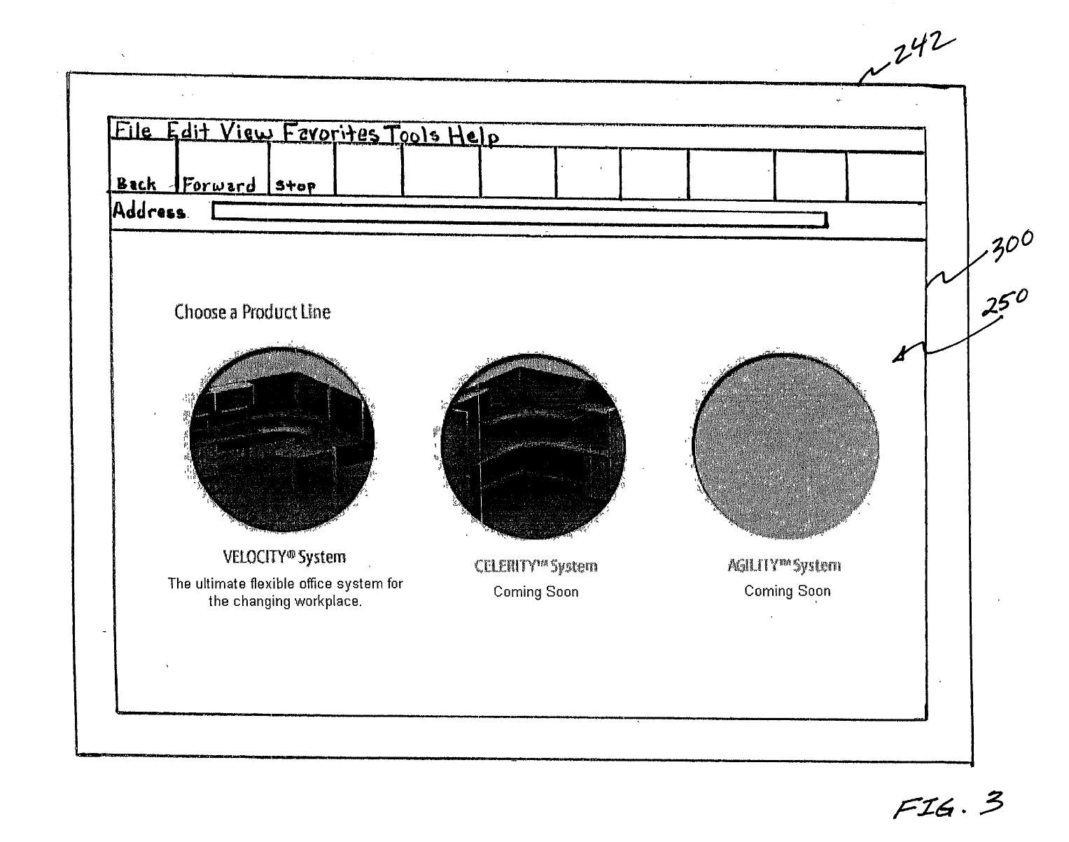

Using a web browser or other non-proprietary software, client computer 130 operated by a customer can access, via network 120, the web page of the office furniture system manufacturer hosted by web server 110. Particular features of the web page are described later below with reference to FIGS. 3-10. By transmitting computer executable instructions from the web server 110 to the client computer 130, and executing the instructions on the client computer, the web browser running on the client computer is caused to prompt the customer to input workstation configuration preferences. The workstation configuration preferences are transmitted by the client computer 130 and are received by the web server 110. Drawing data is retrieved from database 140 for a drawing of a workstation corresponding to the workstation configuration preferences input by the customer. Then, further computer executable instructions are transmitted by the web server 110, through network 120, to client computer 130. These further computer executable instructions correspond to the retrieved drawing data and, when executed on the client computer, cause the web browser on the client computer to display the drawing of the workstation corresponding to the workstation preferences input by the customer.

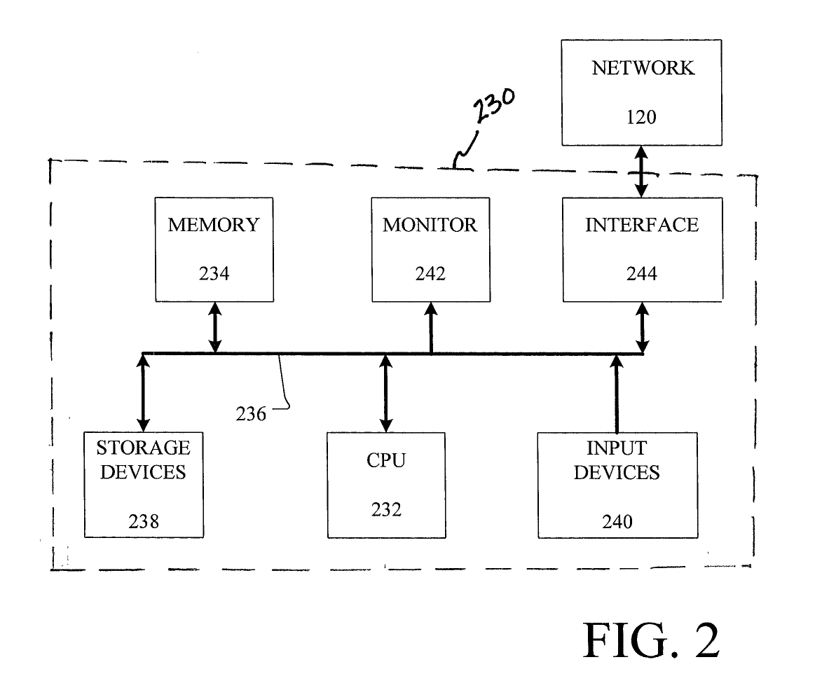

FIG. 2 and the related discussion provide a brief, general description of a computing environment 230 in which the invention may be implemented. The computing environment 230 illustrated in FIG. 2 is exemplary of a computing environment such as client computer 130, but can generally represent a web server environment as well. It must be noted that aspects of the invention are implemented within web server 110, but not necessarily in client computer 130.

Although not required, the present invention will be described, at least in part, in the general context of computer-executable instructions, such as program modules, being executed by a computing environment (such as client computer 130 or a web server computer 110). Generally, program modules include routines programs, objects, components, data structures, etc., which perform particular tasks or implement particular abstract data types. Tasks performed by the program modules are described below with the aid of block diagrams and flow charts. Those skilled in the art can implement the description, block diagrams and flow charts to computer executable instructions. In addition, those skilled in the art will appreciate that the invention may be practiced with other computer system configurations, including multi-processor systems, networked personal computers, mini-computers, mainframe computers, and the like. The invention may also be practiced in distributed computing environments where tasks are performed by remote processing devices that are linked through a communication network. In a distributed environment, program modules and/or data may be located in both local and remote memory storage devices

The computer 230 illustrated in FIG. 2 comprises a conventional computer having a central processing unit (CPU) 232, memory 234 and a system bus 236, which couples various system components, including the memory 234 to the CPU 232. The system bus 236 may be any of several types of bus structures, including a memory bus or a memory controller, a peripheral bus, a network bus and a local bus using any of a variety of bus architectures. The memory 234 includes read-only memory (ROM) and random access memory (RAM). A basic input/output (BIOS) containing the basic routine that helps to transfer information between elements within the computer 230, such as during start-up, is stored in ROM. Storage devices 238, such as a hard disc, a floppy disk drive, an optical disk drive, etc., are coupled to the system bus 236 and are used for storage of program modules and data. It should be appreciated by those skilled in the art that other types of computer readable media that are accessible by a computer, such as magnetic cassettes, flash memory cards, CD-ROM, digital video disks, random access memories, ROMs, and the like may also be used as storage devices. Commonly, programs are loaded into memory 234 from at least one of the storage devices 238 with or without accompanying data. An input device 240, such as a keyboard, pointing device (i.e. mouse, etc.), or the like, allows an operator to provide commands to the computer 230. A monitor or display 242, or other type of output device, is further connected to the system bus 236 via a suitable interface, and provides feedback to the operator. Computer 230 can communicate with other computers, or a network of computers such as the Internet, through a wired or wireless communications link and an interface 244, such as a modem, network card, or the like. In one embodiment, computer 230 can organize, present and solicit information to and from a customer through a website. As discussed above, computing environment 230 can be identified as a server, while remote computers are identified as clients. As discussed above, computer 230 is also generally descriptive of a computing environment which can be used as a client computer 130 (FIG. 1). Remote customers on the client computer can access the website using the client computer and a browser, such as MICROSOFT INTERNET EXPLORER or NETSCAPE NAVIGATOR.

In some embodiments of the present invention, the computer executable instructions contained on a computer readable medium or transmitted in a carrier wave signal include mark-up languages such as HTML, XHTML, CHTML, XML, WML or other mark-up languages frequently used in web page development. However, the present invention is not limited in any respect to embodiments in which the computer executable instructions are embodied as mark-up languages.

FIGS. 3-10 are pictorial illustrations of web pages which can be displayed on a monitor 242 of a client computer 130 using a web browser 300. In a conventional manner, input devices 240 (shown in FIG. 2) such as a keyboard and/or pointing device are used to provide inputs to the client computer in order to effect changes in the web page displayed by web browser 300 and/or to provide information to web server 110 via computer network 120. Although only eight separate web pages are illustrated in FIGS. 3-10, other web pages can be added to the system of the present invention without departing from the spirit and scope of the invention. For example, an initial web page which provides instructions to the customer operating client computer 130 can be included. Further, web pages which assign passwords and assist in log-in procedures can also be added.

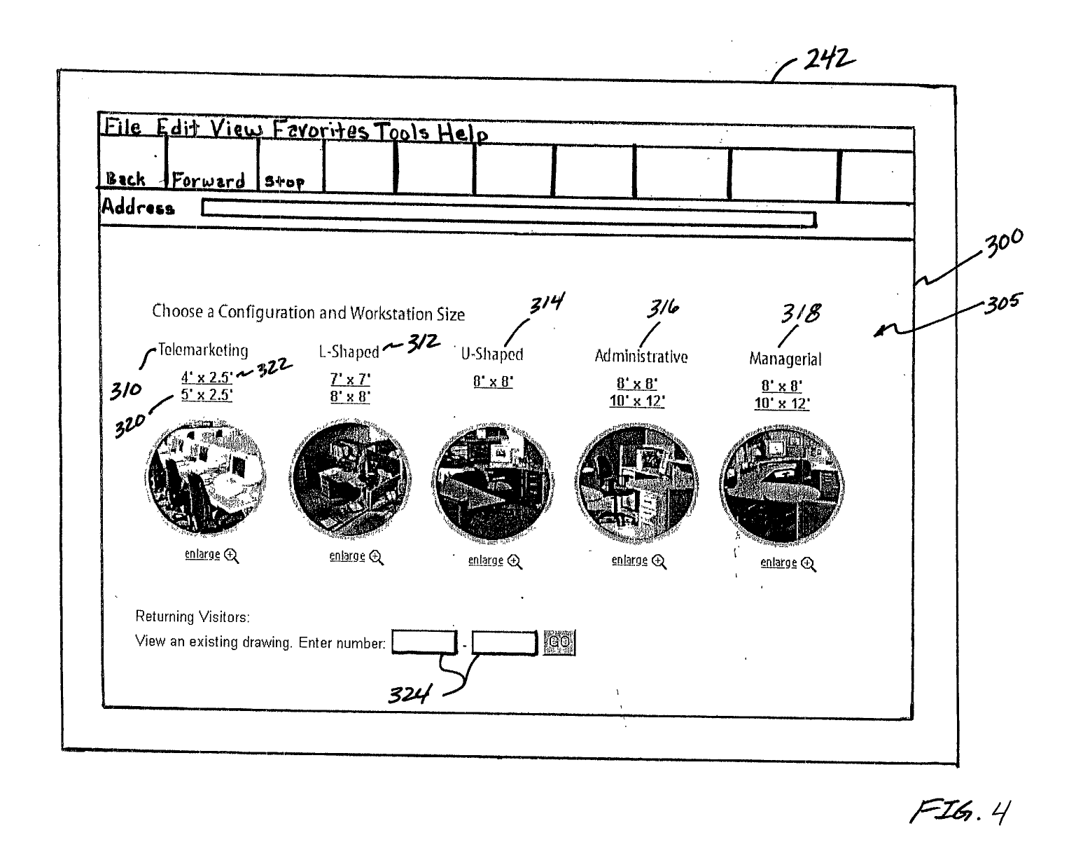

Shown in FIG. 3 is a web page 250 displayed by web browser 300 which prompts the customer or user to choose a product line. This is typically done by using a pointing device to move the on-screen pointer to a selectable item (a designated portion of the web page), and “clicking”. After selecting a product line, a web page 305 (FIG. 4) is displayed which prompts the customer or user of client computer 130 to provide inputs which choose a basic configuration and workstation size. Again, this is typically done by using a pointing device to move the on-screen pointer to a selectable item and clicking.

As shown in FIG. 4 in one particular embodiment, the customer is prompted by web browser 300 to choose a configuration from a list of possible configurations including a “Telemarketing” configuration 310, an “L-Shaped” configuration 312, a “U-Shaped” configuration 314, an “Administrative” configuration 316 and a “Managerial” configuration 318. The user is also prompted to select a workstation size as illustrated in the Telemarketing workstation configuration 310 using selectable items or inputs 320 and 322. Generally, the workstation configuration and workstation size can be simultaneously selected by clicking on the appropriate size selection item under the desired workstation configuration heading. Also, if the customer is a returning visitor, input windows 324 can be used to enter a drawing number corresponding to a particular workstation configuration which the customer may have already selected during a previous visit.

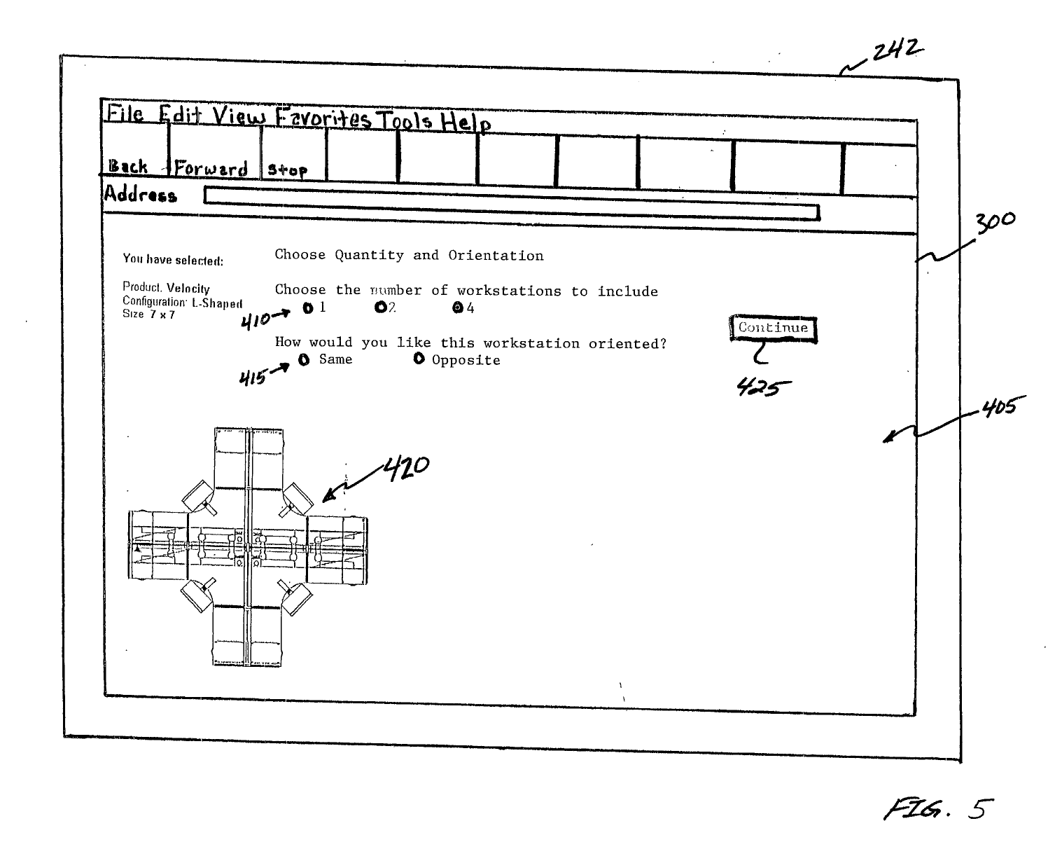

The configuration preferences input by the customer using web page 305 shown in FIG. 4 are transmitted over the computer network to server 110. Using the configuration and size preferences input by the customer in conjunction with web page 305, web server 110 can transmit to client computer 130 computer executable instructions causing subsequent web pages to be displayed. For example, web page 405 shown in FIG. 5 can be displayed in which the customer is prompted to provide additional configuration preferences such as quantity and orientation. In one embodiment, as the customer provides further workstation configuration preferences by clicking on one of selectable items 410 to choose the number of workstations and/or one of selectable items 415 to choose the orientation of the workstations, the computer executable instructions transmitted to client computer 130 are changed such that a top plan view 420 of a workstation corresponding to the combination of preferences is displayed. Once the quantity and orientation configuration preferences are input, the customer can continue the customization process by clicking on the “Continue” item or button 425.

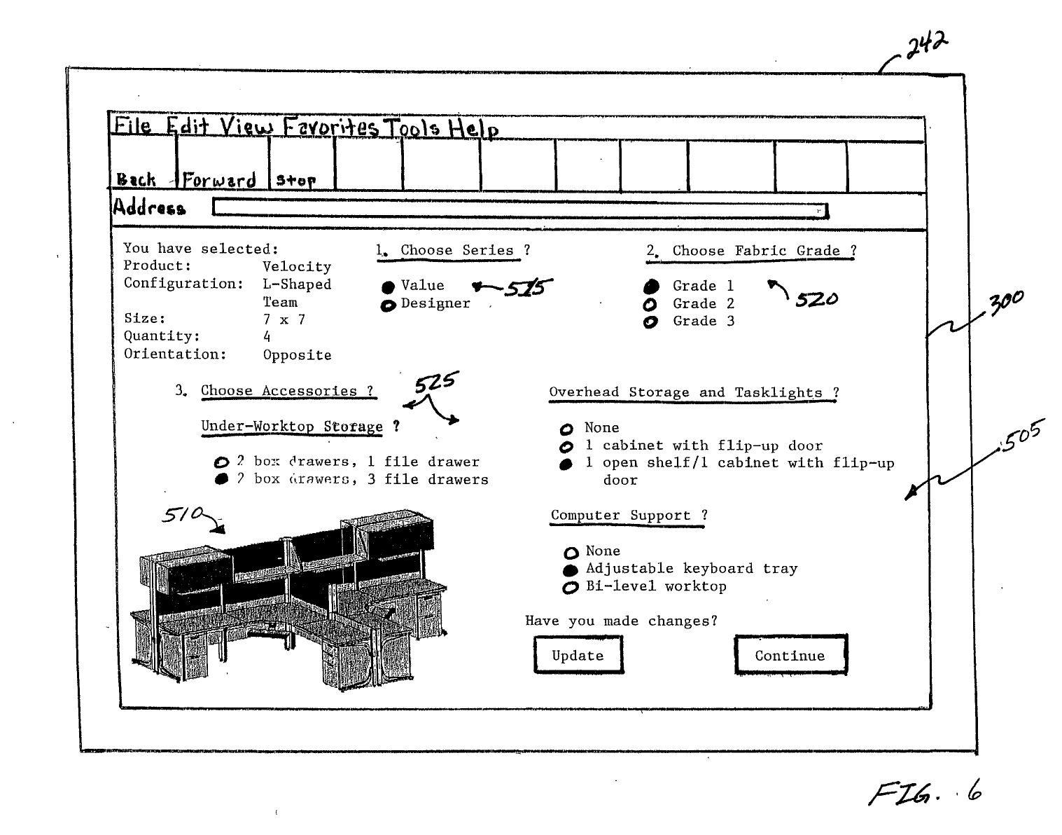

After providing the workstation configuration preferences shown in FIGS. 3-5, web server 110 retrieves drawing data, from database 140 of workstation drawings, for a drawing of a workstation corresponding to the workstation configuration preferences specified by the customer. Then, the web server transmits computer executable instructions corresponding to the retrieved drawing data over the computer network to the client computer. When executed on the client computer these new computer executable instructions cause the web browser 300 on the client computer monitor 242 to display a web page 505 in which a drawing 510 of the workstation corresponding to the workstation preferences is shown. Web page 505 shown in FIG. 6 also provides prompts to the customer to choose additional workstation configuration parameters such as workstation “series” using selectable items 515, workstation “fabric grade” using selectable items 520, and “accessories” using selectable items 525. The accessories include under-worktop storage preferences, overhead storage and task light preferences, and computer support component preferences for example.*

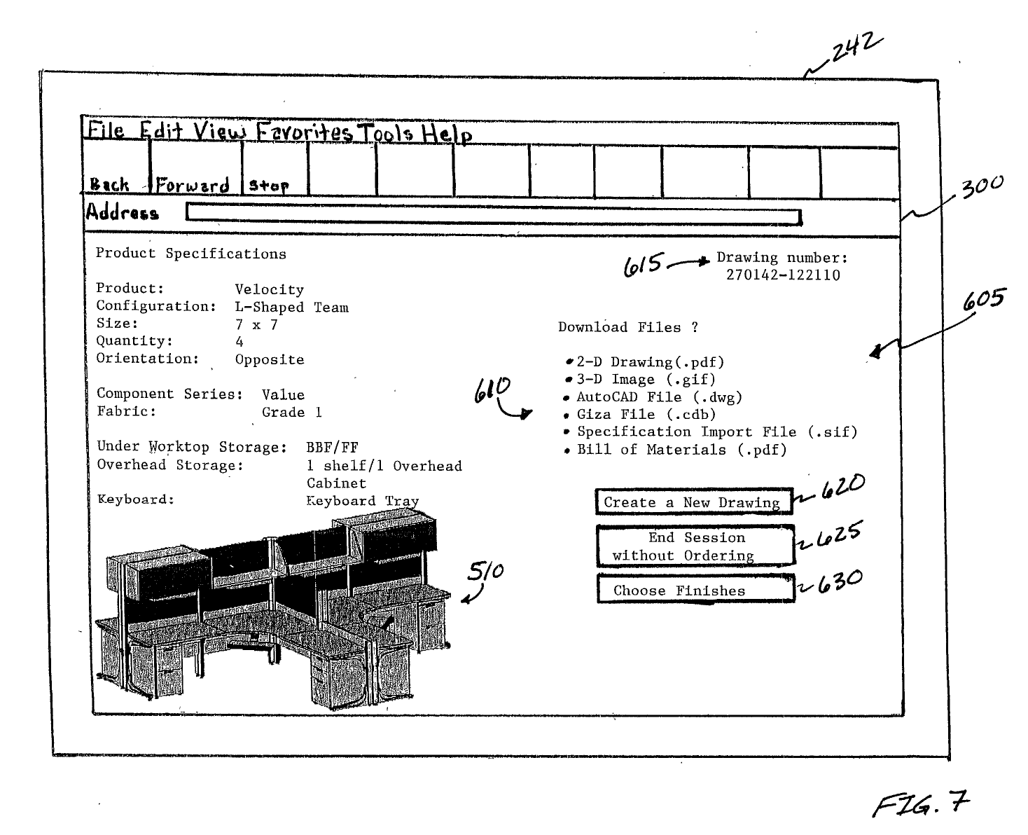

Once all of the workstation configuration preferences have been input by the customer and transmitted to web server 110, web server 110 transmits to client computer 130 computer executable instructions which, when executed on the client computer cause the web browser 300 to display a web page 605 which includes a list 610 of downloadable file types corresponding to the particular workstation preferences input by the customer. In the particular embodiment illustrated in FIG. 7, web page 605 also includes drawing 510 of the workstation as was shown in FIG. 6. Further, web page 605 displays a drawing number 615 corresponding to the particular workstation preferences input by the customer.

Downloadable files 610 is a list of selectable items or links which, when clicked upon by the customer, will result in transfer of the selected file type from web server 110 to client computer 130. In the particular embodiment illustrated in FIG. 7, the downloadable file types, each of which correspond to the particular set of workstation preferences input by the customer, include the following:

(1) a 3-dimmensional rendering of the workstation (3-D.gif or other file types);

(2) a two-dimensional plan view of the workstation (2-D.pdf or other file types);

(3) an AutoCAD readable file (AutoCAD.dwg) which is in a format that can be used to make changes to the drawing using AutoCAD software;

(4) a GIZA readable file (GIZA.cdb) which is in a format that can be used to make changes to the drawing using GIZA software;

(5) a standard interface file (.sif) that can be used to electronically populate the manufacturer's business system with a purchase order, thus eliminating the need for manual re-entry of order data; and

(6) a Bill of Materials file (Bill of Materials.rtf), which is a text version of the order including part numbers, quantities and list prices.

The downloadable file types 610 can be used by the customer to make changes to the work station level drawings, .sif file, Bill of Materials file, etc. Once the changes are made, the revised files can be transmitted to the manufacturer's system via e-mail or other electronic techniques. If desired, a revised Bill of Materials file can be printed out and faxed to the manufacturer in order to place the order.

Also illustrated in FIG. 7 are three additional buttons or selectable items: “Create a New Drawing” item 620, “End of Session Without Ordering” item 625, and “Choose Finishes” item 630. If the customer wishes to start the process over and create a new drawing, item 620 is selected. If the customer wishes to end the customizing session without ordering, item 625 is selected. If the customer wishes to proceed with the customization process, “Choose Finishes” item 630 is selected, which causes the web server 110 to transmit to client computer 130 computer executable instructions which, when executed on the client computer, cause the web browser 300 to display a web page 650.

Web page 650 presents the customer with “swatch board” selectable items 655 (655A through 655E are shown) which facilitate the selection of fabrics and finishes for the workstation. The selections presented are dynamic based on the drawing selected by the customer or user. For example, if the customer has selected a workstation that does not contain any overhead storage, then the “Overhead Fabric” selection 655C would not be presented. When initially presented, the swatch boards 655 are empty. As the user clicks on each swatch board selection 655, all fabrics or finishes (collectively “swatches” 660) allowed for that selection are displayed at the bottom of the screen. The user then picks one of those “swatches” 660 by clicking on it and the system then moves that swatch to the currently active swatch board 655. The swatch board selections can be changed by either clicking on the edit button 665 below the swatch selection or clicking on the swatch Only when the user has selected all the required fabrics and finishes does the “Finalize Order” button 670 become active.

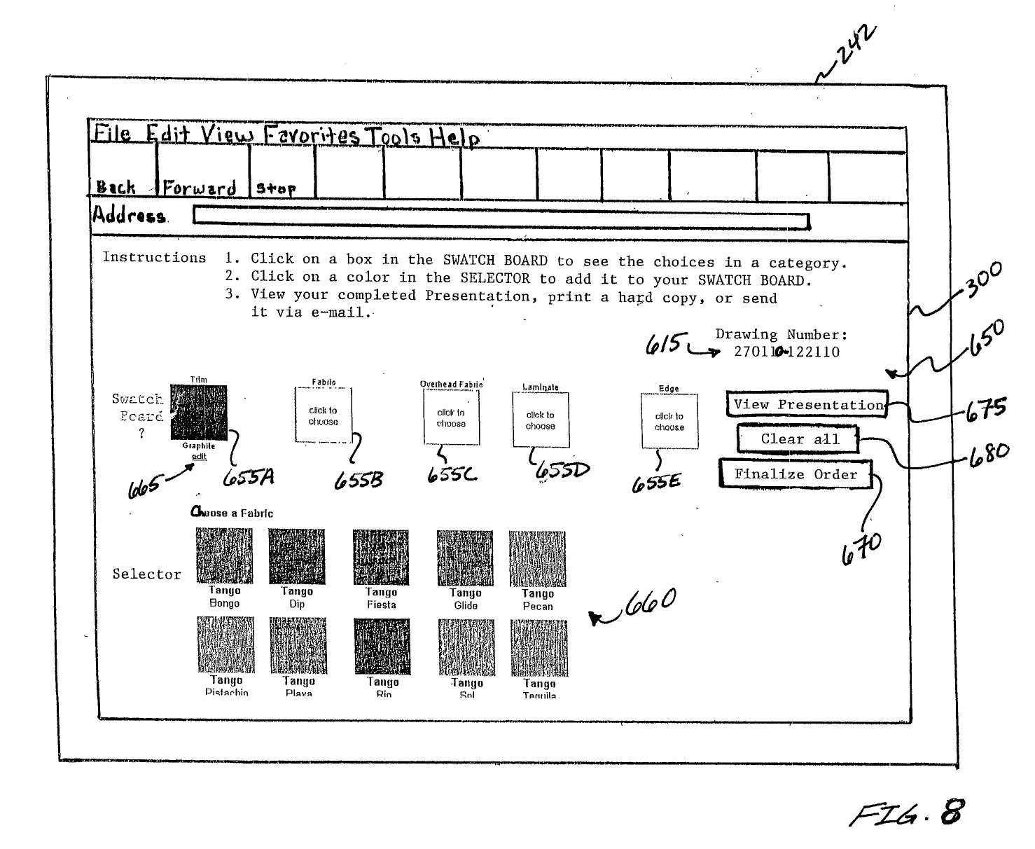

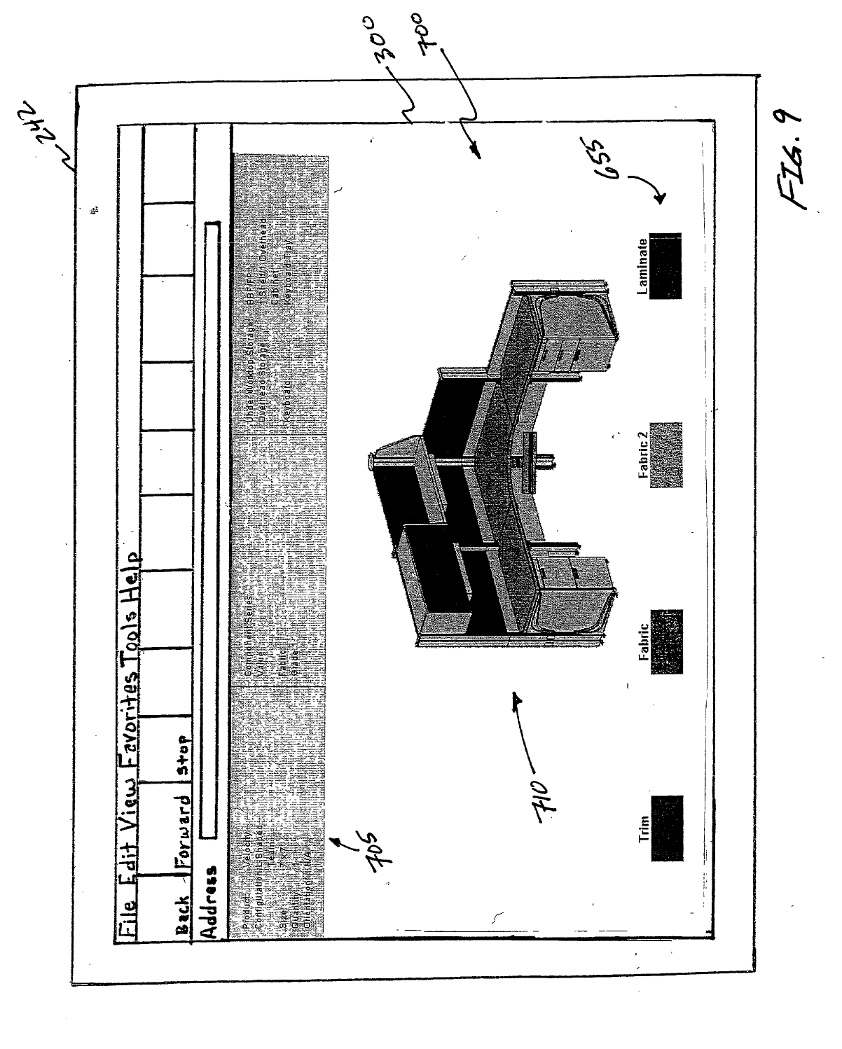

The customer or user can view their order by clicking the “View Presentation” button 675. This causes the web server 110 to transmit to client computer 130 computer executable instructions which, when executed on the client computer, cause the web browser 300 to display a web page or window 700 shown in FIG. 9. Window 700 shows the parameters 705 selected by the customer, a 3-D rendering 710 of the workstation, and the swatch board 655 that they created. The customer can save this swatch board in a file if they choose. The customer can also go back to page 650 (FIG. 8) and edit the swatch board, view and save the presentation as many times as they like. This method allows them to create several swatch boards for the same drawing. If the user or customer is for example a dealer, this enables them to present the ultimate purchaser with multiple color combinations.

Referring back to FIG. 8, when the customer or user clicks on “Finalize Order” button 670, they are presented with a page 750 that asks them for their name, email address and ship to information. The customer submits this information and their drawing by clicking on “Submit an Order” button 755 at the bottom of this page. This submits an order for the workstation corresponding to the specified preferences and identified by the drawing number 615. In one embodiment, clicking on the “Submit an order” item 620 causes an e-mail to be automatically generated and transmitted to the manufacturer for placement. In one particular embodiment, the e-mail contains the drawing number 615 being ordered, the fabric and finish selections from the screen or web page 505 and other information such as the ship to information.

The designer product customizing web site based concepts of the present invention provide a number of unique features. The workstation embodiments illustrated do not limit the invention, as the invention is directed to more general designer products. Since the website allows selection and downloading of one of many (e.g., thousands) prepackaged typical product configurations corresponding to the desired preferences, rather than requiring the customer to build-up the system from components or modules, the processing power and bandwidth necessary for a web-based CAD system is not required. By having a large number of pre-packaged designs, the flexibility of a traditional system is simulated without the programming or usage complexity. The fundamental element used in the concepts of the present invention is the designer product (for example, a workstation), rather than the component or module. This distinction is important in that users of designer products such as office furniture systems think in terms of top level products (for example workstations), and not in terms of the component parts (e.g., cantilevers, feet, brackets, etc.). By providing the grossly correct solution (i.e., workstations) and then allowing customization, significant time, manpower and processing is saved in comparison to solutions in which the desired designer product is built-up piece by piece for each customer.

As shown in FIG. 7, the customer is provided with multiple methods or types of output to enable “instant” sales documentation and to allow further modification of the pre-packaged typical designer product configurations with a stand-alone CAD system (for example, running on a client computer). In addition, files are provided which facilitate integration with the user's business system.

Since the system of the present invention is web-based, it does not require the customer to have proprietary software specific to the manufacturer's system. The only software required in the client computer used by the customer is an internet browser and e-mail software. Thus, the customer can access the system from any computer connected to the internet. The manufacturer can control access by the assignment “guest” access to registered users. A further advantage of the system of the present invention is that it does not require any knowledge, by the customer, of the designer product components in order to achieve accurate results. Further, computational elements of the system run on the web server, and not on the customer's computer.

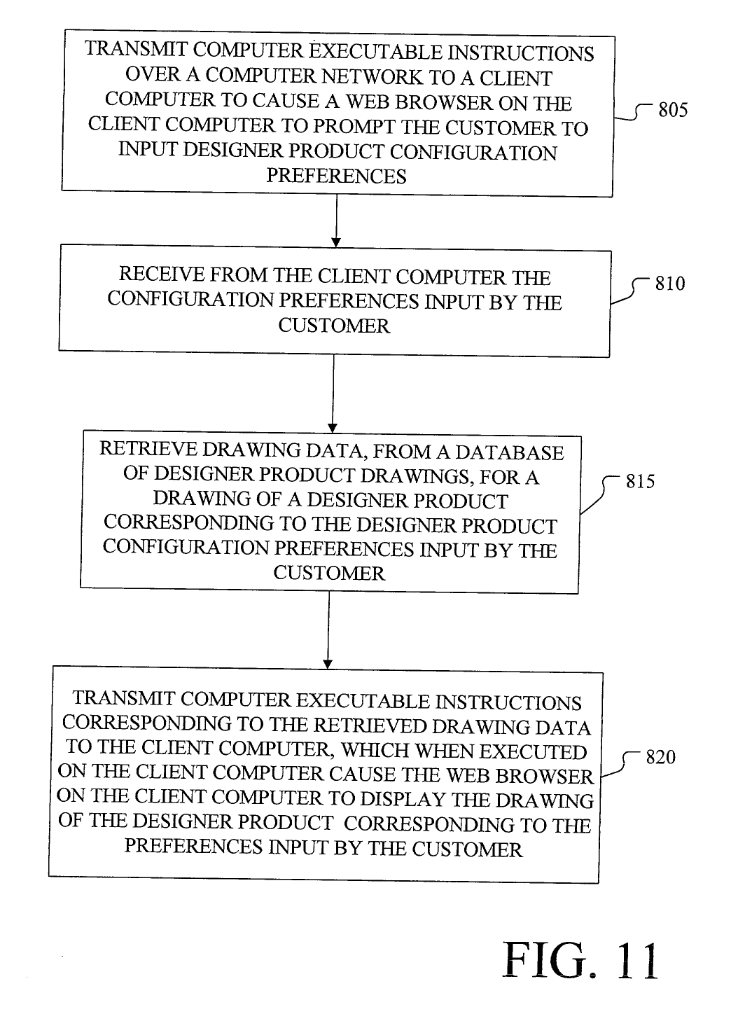

The methods of the present invention can be expressed in a variety of differing forms, including methods which comprise transmitting and receiving computer executable instructions for performing one or more of the above-described steps. One exemplary embodiment is described in the following summary with reference to FIG. 11. The steps illustrated in FIG. 11 are for a method of providing designer product planning information to a customer of a designer product manufacturer in order to customize designer products comprised of combinations of components and/or modules. The method assumes that the customer is operating a client computer in communication with a web server via a computer network.

As shown at block 805, the method includes the step of transmitting computer executable instructions over the computer network to the client computer, which when executed on the client computer cause a web browser on the client computer to prompt the customer to input designer product configuration preferences. At block 810, the method is shown to include the step of receiving, over the computer network from the client computer, the configuration preferences input by the customer. Receipt of the preferences is generally at the web server.

Next, as shown at block 815, the method includes the step of retrieving drawing data, from a database of designer product drawings, for a drawing of a designer product corresponding to the configuration preferences input by the customer. The database of drawings is a database of pre-prepared drawings, each corresponding to a different set of designer product configuration preferences. Then, as shown at step 820, the method includes the step of transmitting computer executable instructions corresponding to the retrieved drawing data, over the computer network to the client computer, which when executed on the client computer cause the web browser on the client computer to display the drawing of the designer product corresponding to the preferences input by the customer. These method steps can include further details, as described above with reference to FIGS. 1-10.

Although the present invention has been described with reference to preferred embodiments, workers skilled in the art will recognize that changes may be made in form and detail without departing from the spirit and scope of the invention.

What is claimed is:

1. A method of providing designer product planning information to a customer of a designer product manufacturer in order to customize designer products comprised of combinations of components and/or modules, the customer operating a client computer in communication with a computer network, the method comprising:
transmitting computer executable instructions over the computer network to the client computer, which when executed on the client computer cause a web browser on the client computer to prompt the customer to input designer product configuration preferences;
receiving over the computer network from the client computer the designer product configuration preferences input by the customer;
retrieving drawing data, from a database of designer product drawings, for a drawing of a designer product corresponding to the configuration preferences input by the customer; and
transmitting computer executable instructions corresponding to the retrieved drawing data over the computer network to the client computer, which when executed on the client computer cause the web browser on the client computer to display the drawing of the designer product corresponding to the configuration preferences input by the customer.

2. The method of claim 1, wherein the designer product is an office furniture system workstation.

3. The method of claim 2, wherein transmitting computer executable instructions over the computer network to the client computer, which when executed on the client computer cause the web browser on the client computer to prompt the customer to input designer product configuration preferences, further comprises:
transmitting computer executable instructions over the computer network to the client computer, which when executed on the client computer cause the web browser on the client computer to prompt the customer to input a preferred workstation configuration.

4. The method of claim 3, wherein transmitting computer executable instructions over the computer network to the client computer, which when executed on the client computer cause the web browser on the client computer to prompt the customer to input designer product configuration preferences, further comprises:
transmitting computer executable instructions over the computer network to the client computer, which when executed on the client computer cause the web browser on the client computer to prompt the customer to input a preferred workstation size.

5. The method of claim 4, wherein transmitting computer executable instructions over the computer network to the client computer, which when executed on the client computer cause the web browser on the client computer to prompt the customer to input designer product configuration preferences, further comprises:
transmitting computer executable instructions over the computer network to the client computer, which when executed on the client computer cause the web browser on the client computer to prompt the customer to input a preferred workstation quantity.

6. The method of claim 5, wherein transmitting computer executable instructions over the computer network to the client computer, which when executed on the client computer cause the web browser on the client computer to prompt the customer to input designer product configuration preferences, further comprises:
transmitting computer executable instructions over the computer network to the client computer, which when executed on the client computer cause the web browser on the client computer to prompt the customer to input a preferred workstation orientation.

7. The method of claim 6, wherein transmitting computer executable instructions over the computer network to the client computer, which when executed on the client computer cause the web browser on the client computer to prompt the customer to input designer product configuration preferences, further comprises:
transmitting computer executable instructions over the computer network to the client computer, which when executed on the client computer cause the web browser on the client computer to prompt the customer to input at least one of fabric grade preferences, under-worktop storage component and/or module preferences, overhead storage component and/or module preferences, computer support component and/or module preferences, and series type preferences.

8. The method of claim 1, wherein transmitting computer executable instructions corresponding to the retrieved drawing data over the computer network to the client computer, which when executed on the client computer cause the web browser on the client computer to display the drawing of the designer product corresponding to the designer product preferences input by the customer further comprises:
transmitting computer executable instructions over the computer network to the client computer, which when executed on the client computer cause the web browser on the client computer to display a plurality of different downloadable file types, each corresponding to the designer product preferences input by the customer.

9. The method of claim 8, wherein the plurality of different file types include one or more of a three dimensional drawing file, a two dimensional drawing file, a CAD drawing, a GIZA drawing, a standard interface file, and a Bill of Materials file.

10. The method of claim 8, and further comprising:
receiving over the computer network from the client computer a request to download one of the plurality of different file types corresponding to the designer product preferences input by the customer; and
transmitting over the computer network to the client computer the requested one of the plurality of different file types corresponding to the designer product preferences input by the customer.

11. The method of claim 1, and further comprising:
transmitting computer executable instructions over the computer network to the client computer, which when executed on the client computer cause the web browser on the client computer to query the user to provide an input indicative of a desire to order the designer product corresponding to the designer product preferences input by the customer; and
receiving over the computer network from the client computer an order for the designer product corresponding to the designer product preferences input by the customer.
